(19) United States
(12) Patent Application Publication
(10) Pub. No.: US 2013/0309055 A1
(43) Pub. Date: Nov. 21, 2013

(54) ROBOT TURNING APPARATUS FOR EXTENDING WORKING AREA OF ROBOT

(71) Applicant: FANUC CORPORATION, Minamitsuru-gun (JP)

(72) Inventor: Toshimichi Yoshinaga, Minamitsuru-gun (JP)

(73) Assignee: FANUC CORPORATION, Minamitsuru-gun (JP)

(21) Appl. No.: 13/845,683

(22) Filed: Mar. 18, 2013

(30) Foreign Application Priority Data
May 15, 2012 (JP) 2012-111404

(51) Int. Cl. B25J 18/04

(52) U.S. Cl. CPC B25J 18/04
USPC 414/680

(57) ABSTRACT

A robot turning apparatus capable of considerably extending a working area of a robot without using a traveling axis, etc., which is also advantageous in terms of maintenance and cost. The turning apparatus has a base section arranged on a floor surface; a turning section connected to the base section so as to be turned about a turning axis; a robot mounting section for mounting the robot thereon, formed on the turning section; and a driving section which turns the turning section. The robot has a robot base part, and a robot arm part attached to the robot base part so as to be rotated about a rotation axis, wherein the robot base part is attached to the robot Mounting section so that the rotation axis is offset from the turning axis in a horizontal direction by a predetermined distance.

### BACKGROUND OF THE INVENTION

1. Field of the Invention

The present invention relates to a robot turning apparatus for extending a working area of an industrial robot.

2. Description of the Related Art

In a production system using an industrial robot, it is desirable that a working area be extended as possible in order to reduce cost and be more efficient. For example, Japanese Unexamined Patent Publication (Kokai) No. 2005-46966, which discloses a production system, describes that “in the present production system, dual-arm robot 1 is constituted by combining conventional robot arms 7 and 8, whereby the cost of facilities may be low in comparison to an expensive multi-joint robot arm. Further, dual-arm robot 1 may travel on traveling rail (or traveling axis) 10 and may be positioned at an arbitrary position, whereby only one dual-arm robot 1 is necessary in order to give or receive workpiece 6 between the robot and each machine tool 2 to 4.”

Japanese Unexamined Patent Publication (Kokai) No. 5-76965, which discloses a work pressing apparatus machine using a press machine and a robot, describes that “even when the distance between press machines is large, by the combination of linear traveling of a robot pedestal along a linear track arranged between the machines, rotational motion of the robot arm about a vertical axis of the robot pedestal, and telescopic motion of the robot arm along an arm axis, a hand for gripping may be moved between one press machine and the other press machine in a short time. Therefore, cycle time for automatically conveying the workpiece can be lowered.”

Further, Japanese Unexamined Patent Publication (Kokai) No. 2010-221355, which discloses a robot system including a multi-joint robot, describes that “a multi-joint robot is connected to a turning unit so that a pivot axis of a robot arm of the robot and a rotation axis of a turning table of the turning unit are not parallel to each other, degree of freedom of the robot is increased by one. Therefore, an inexpensive robot system may be provided while increasing the degree of freedom of the robot.”

In the production system as described in Japanese Unexamined Patent Publication (Kokai) No. 2005-46966, in order to give or receive the workpiece between the industrial robot and each machine tool, the traveling rail, on which the robot can travel, is arranged along a production line. However, since it is necessary to arrange the traveling rail in front of each machine tool, the production system is not preferable in terms of, maintenance thereof.

In the pressing apparatus as described in Japanese Unexamined Patent Publication (Kokai) No. 5-76965, the press machine is usually arranged in a pit, and an area around the press machine or between each press machine is often covered or protected by a pit cover. Therefore, it may be difficult to constitute the traveling rail.

Further, in the robot system as described in Japanese Unexamined Patent Publication (Kokai) No. 2010-221355, although the robot is positioned on the turning unit, this is intended to increase the degree of freedom of the robot, not to considerably extend a working area of the robot.

### SUMMARY OF THE INVENTION

An object of the present invention is to provide a robot turning apparatus capable of considerably extending a working area of a robot without using a traveling axis, etc., which is also advantageous in terms of maintenance and cost.

According to the present invention, a turning apparatus for a robot is provided, the turning apparatus comprising: a base section arranged on a floor surface; a turning section connected to the base section so that the turning section may be turned about a turning axis extending in a vertical direction; a robot mounting section for mounting the robot thereon, formed on the turning section; and a driving section which turns the turning section about the turning axis, wherein the robot mounted on the robot mounting section has a robot base part, and a robot arm part attached to the robot base part so that the robot arm part may be rotated about a rotation axis extending in a vertical direction, and wherein the robot base part is attached to the robot mounting section so that the rotation axis is offset from the turning axis in a horizontal direction by a predetermined distance.

In a preferred embodiment, the turning apparatus comprises a counterbalance positioned on a portion of the turning section, the portion being opposed to the robot mounting section with respect to the turning axis.

In a preferred embodiment, the turning apparatus comprises a fixing and supporting device arranged on the floor below a working position of the robot, the fixing and supporting device being configured to fix and support the turning section from below.

### BRIEF DESCRIPTION OF THE DRAWINGS

The above and other objects, features and advantages of the present invention will be made more apparent by the following description of the preferred embodiments thereof with reference to the accompanying drawings wherein:

FIG. 1 shows a robot turning apparatus according to a first embodiment of the present invention;

FIG. 2 shows a robot turning apparatus according to a second embodiment of the present invention;

FIG. 3 shows an example wherein a fixing and supporting device is further arranged in the turning apparatus;

FIG. 4 shows the fixing and supporting device of FIG. 3 in a release state thereof; and

FIG. 5 shows an example of a system wherein the turning apparatus of FIG. 3 is positioned between press machines.

### DETAILED DESCRIPTION

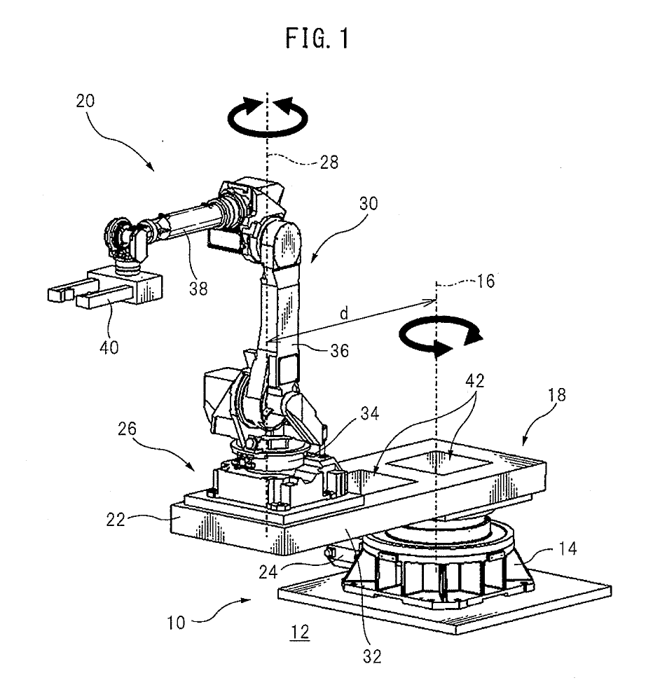

FIG. 1 is a perspective view showing a robot turning apparatus according to a first embodiment of the present invention. A turning apparatus 10 has a base section 14 arranged on a floor surface or installation surface 12; a turning section 18 connected to base section 14 so that turning section 18 may be turned about a turning axis 16 extending in a vertical direction; a robot mounting section 22 for mounting a robot 20 thereon, formed on turning section 18; and a driving section 24, such as a motor, which turns turning section 18 about turning axis 16.

Robot 20 mounted on robot mounting section 22 has a robot base part 26 attached to robot mounting section 22, and a robot arm part 30 attached to robot base part 26 so that robot arm part 30 may be rotated about a rotation axis 28. Robot base part 28 is attached to robot mounting section 22 so that rotation axis 28 extends in a vertical direction and so that rotation axis is offset from turning axis 16 in a horizontal direction by a predetermined distance “d.” In other words, turning section 18 has a first portion 32 extending from turning axis 16 in a generally horizontal direction, and robot mounting section 22 is formed on first portion 32.

By virtue of such a configuration, robot base part 28 may be moved generally along a circumference having a radius corresponding to offset distance “d,” in other words, robot base part 28 may be moved relative to floor surface 12 by at most a distance corresponding to double of offset distance “d.” Therefore, a working area of robot 20 may be considerably extended without using a traveling device, etc. Further, since it is not necessary to arrange a traveling rail, etc., on the floor surface, a space for maintenance or mold exchanging by using a forklift, etc., may be easily obtained, for example, when the present invention is applied to a system including a press machine.

In the illustrated embodiment, robot arm part 30 has a rotating body 34 attached to robot base part 26 so as to rotate about rotation axis 28, an upper arm 38 rotatably attached to rotating body 34, a forearm 38 rotatably attached to upper arm 36, and a robot hand 40 rotatably attached to forearm 38. However, the application of the invention is not limited to the robot having such a configuration. In addition, the shape and/or material of turning section 18 may be determined based on the desired working area of the robot and/or the weight of the robot. In this regard, as shown in FIG. 1, one or more opening 42 having a proper size may be formed in turning section 18 in order to reduce the weight of the turning section.

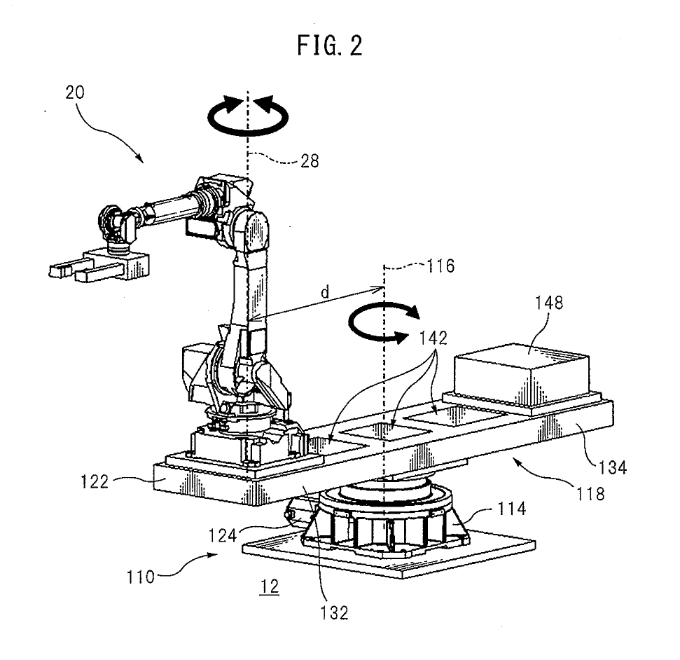

FIG. 2 is a perspective view showing a robot turning apparatus according to a second embodiment of the present invention. A turning apparatus 110 has a base section 114 arranged on a floor surface or installation surface 12; a turning section 118 connected to base section 114 so that turning section 118 may be turned about a turning axis 116 extending in a vertical direction; a robot mounting section 122 for mounting a robot 20 thereon, formed on turning section 118; and a driving section 124, such as a motor, which turns turning section 118 about turning axis 116. Robot 20 mounted on robot mounting section 120 may be the same as in FIG. 1, and the positional relationship between robot 20 and turning axis 116 may equivalent to FIG. 1. Therefore, a detail explanation thereof is omitted.

The configuration of turning apparatus 110 of the second embodiment is different from turning section 18 of the first embodiment. Concretely, turning section 118 has a first portion 132 extending from turning axis 116 in a generally horizontal direction, robot mounting section 122 formed on first portion 132, a second portion 134 extending in a generally horizontal direction opposed to first portion 132, and a counterbalance 148 positioned on second portion 134.

In the second embodiment, counterbalance 148 is positioned on a portion of turning section 118, the portion being opposed to robot mounting section 122 with respect to turning axis 116. In the second embodiment, turning section 118 is not a cantilever structure such as turning section 18 which is supported by base section 14. Instead, turning section 118 is supported by based section 114 at the generally center thereof, and has two loads (i.e., root 20 and counterbalance 148) positioned at both sides thereof. Therefore, a moment applied to turning apparatus 110 may be lowered, as a result, the cost (or design strength) of the turning apparatus may be reduced. The shape and/or material of turning section 118 may be determined based on a desired working area of the robot and the weights of the robot and the counterbalance, etc. In this regard, as shown in FIG. 2, one or more opening 142 having a proper size may be formed in turning section 18 in order to reduce the weight of the turning section.

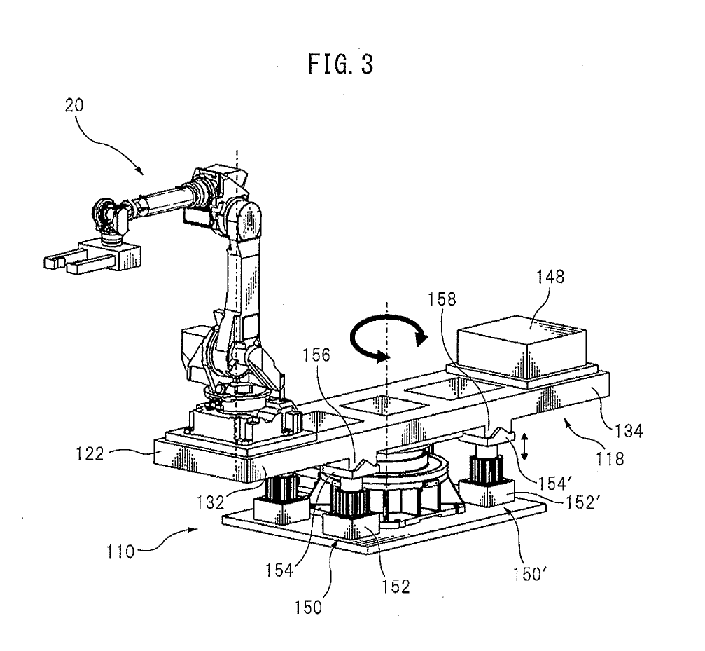

FIG. 3 shows an example wherein turning apparatus 110 of the second embodiment has a fixing and supporting device 150 arranged on the floor below a working position of robot 20, the fixing and supporting device being configured to fix and support turning section 118 from below. Fixing and supporting device 150 has a body part 152 arranged on the floor surface and a movable supporting part 154 configured to be moved relative to body part 152 in the generally vertical direction. For example, fixing and supporting device 150 may have the constitution of a hydraulic cylinder or a pneumatic cylinder. In addition, an upper end portion of movable supporting part 154 may have the shape which can engage a lower surface of turning section 118 without backlash, when turning section 118 is positioned at a predetermined turning angle.

In the embodiment of FIG. 3, a concave portion 156 is formed on the lower surface of first portion 132 of turning section 118, and an upper portion of movable supporting part 154 of device 150 positioned below concave portion 156 is formed as a convex portion which has a complementary shape to concave portion 156. Similarly, a concave portion 158 is formed on the lower surface of second portion 134 of turning section 118, and an upper portion of movable supporting part 154′ of fixing and supporting device 150′, similar to device 150, positioned below concave portion 158 is formed as a convex portion which has a complementary shape to concave portion 156. However, the present invention is not limited to such an embodiment. For example, a convex portion may be formed on the lower surface of turning section 118, and the upper portion of the movable supporting part of the device may be formed as a concave portion which is adapted to engage the convex portion.

By using the fixing and supporting device, turning section 118 may be accurately positioned and held at a turning angular position corresponding to the working position of robot 20, whereby operational stability of robot 20 may be improved. Further, since the fixing and supporting device may support the weight of robot 20 and/or the operation load applied to robot 20 during the operation thereof, from below turning section 118, the rigidity and/or the strength of the turning apparatus (or the turning section) may be lowered, whereby the cost of the turning apparatus may be reduced. However, the fixing and supporting device may be applied to turning apparatus 10 of FIG. 1.

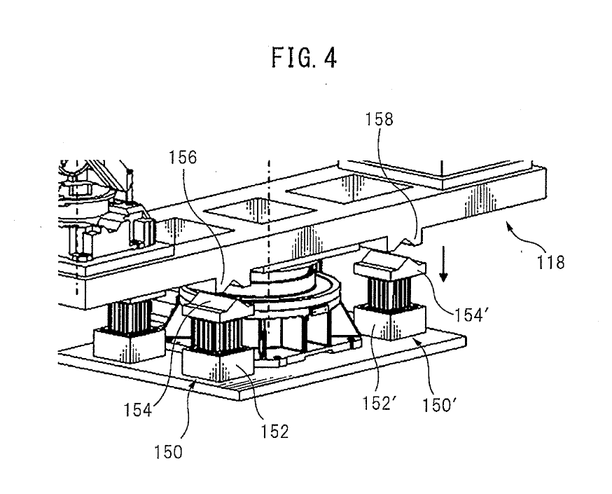

FIG. 4 shows a state wherein fixing/supporting of turning section 118 by the fixing and supporting device is released. Concretely, movable supporting parts 154 and 154′ of fixing and supporting devices 150 and 150′ are downwardly moved so as to detach from concave portions 156 and 158, respectively, so that turning section 118 may be turned. Although four fixing and supporting devices are used in the embodiment of FIG. 4, certain fixing/supporting effect may be obtained by only one fixing and supporting device. In other words, the number of the fixing and supporting devices may be determined based on the shape of the turning section and/or the weight of the robot.

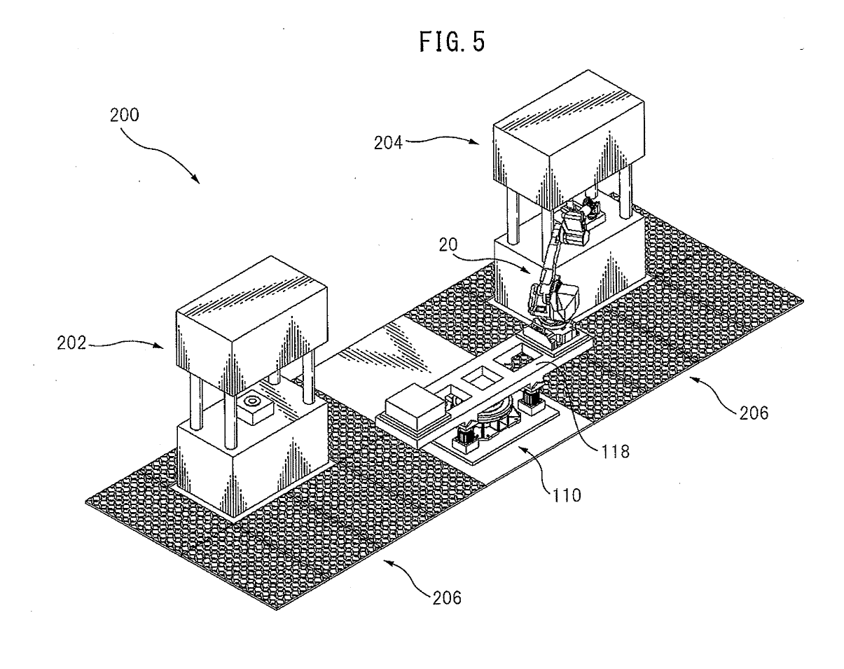

FIG. 5 is a perspective view of a pressing system including robot turning apparatus 110 as shown in FIG. 3. Pressing system 200 has first and second press machines 202 and 204, which are separated from each other by a predetermined distance, and robot turning apparatus 110 as shown in FIG. 3, wherein turning apparatus 110 is located at a generally intermediate position between the press machines. In system 200, by using robot 20 mounted on turning apparatus 110, a work is delivered from first press machine 202 to second press machine 204 (or vice versa). A pit is formed around each press machine, and a deck 206 for an operator is constituted in the pit.

In system 200 as shown in FIG. 5, offset distance “d” as shown in FIG. 2 is determined so that robot 20 can access a plurality of machines (press machines 202 and 204 in this case) which are separated from each other. By virtue of this, by the turning motion of turning section 118 and the motion of (the arm of) robot 20, robot 20 may approach either of the press machines, whereby the robot can carry out a predetermined operation such as delivering/receiving of the work between the press machines. In other words, in the system of the invention, one robot may approach either of the two press machines which are widely separated from each other, without arranging a fixed structure such as a traveling rail for the robot. Further, although it is necessary to move robot 20 from a front area (or diagonally downward right area in FIG. 5) of each press machine when exchanging a mold in the press machine or when carrying out maintenance of the press machine, it is not necessary to arrange the structure such as the traveling rail in the front area of the press machine, nor to position the body of the robot in the front area, in the system of the invention. Therefore, the maintenance of the press machine may be facilitated.

According to the present invention, by positioning the robot offset from the turning axis of the turning section, the working area of the robot obtained by the turning motion of the turning section can be widely extended. Therefore, a system, wherein one robot can deliver a work between a plurality of machines such as press machines, can be realized without using a traveling axis or traveling rail. Further, since it is not necessary to arrange a fixed structure such as the traveling rail in the front area of the machine, a space for the maintenance and/or exchanging the mold by using a forklift may be obtained.

By arranging the counterbalance on the turning section, the turning section can be configured as a both end support structure, not a cantilever structure. Therefore, a moment applied to the turning apparatus is lowered, and the cost of the turning apparatus may be reduced.

By using the fixing and supporting device, the operation load of the robot can be supported by the device, whereby the rigidity and/or the strength of the turning apparatus may be lowered, and the cost of the turning apparatus may be reduced.

While the invention has been described with reference to specific embodiments chosen for the purpose of illustration, it should be apparent that numerous modifications could be made thereto, by a person skilled in the art, without departing from the basic concept and scope of the invention.

1. A turning apparatus for a robot, comprising:
a base section arranged on a floor surface;
a turning section connected to the base section so that the turning section may be turned about a turning axis extending in a vertical direction;
a robot mounting section for mounting the robot thereon, formed on the turning section; and
a driving section which turns the turning section about the turning axis,
wherein the robot mounted on the robot mounting section has a robot base part, and a robot arm part attached to the robot base part so that the robot arm part may be rotated about a rotation axis extending in a vertical direction, and
wherein the robot base part is attached to the robot mounting section so that the rotation axis is offset from the turning axis in a horizontal direction by a predetermined distance.

2. The turning apparatus as set forth in claim 1, wherein the turning apparatus comprises a counterbalance positioned on a portion of the turning section, the portion being opposed to the robot mounting section with respect to the turning axis.

3. The turning apparatus as set forth in claim 1, wherein the turning apparatus comprises a fixing and supporting device arranged on the floor below a working position of the robot, the fixing and supporting device being configured to fix and support the turning section from below.
